(19) United States
(12) Patent Application Publication
(10) Pub. No.: US 2013/0036892 A1
(43) Pub. Date: Feb. 14, 2013

(54) SET OF ORGAN PIPES

(71) Applicant: Denys Delporte, Kain (BE)

(72) Inventor: Denys Delporte, Kain (BE)

(21) Appl. No.: 13/638,995

(22) PCT Filed: Apr. 1, 2011
(86) PCT No.: PCT/EP11/55121

§ 371 Date: Oct. 2, 2012

(30) Foreign Application Priority Data
Apr. 2, 2010 (BE) 2010/0215

(51) Int. Cl. G10B 1/02

(52) U.S. Cl. 84/348; 84/331

(57) ABSTRACT

The present invention relates to a set of organ pipes including at least 54 pipes, characterized in that said set has a variation in the richness of the harmonics generated by said pipes during use, and in that the ratio of the intensity of the first harmonic to the intensity of the fundamental is at a maximum at a frequency between 150 and 500 Hz, preferably between 200 and 300 Hz, wherein said maximum is different by at least 20 dB with respect to the ratio of the intensity of the first harmonic to the fundamental of the pipe producing the lowest frequency note.

### SUBJECT-MATTER OF THE INVENTION

The present invention relates to ranks of organ pipes and musical instruments comprising such ranks.

### BACKGROUND OF THE INVENTION

The organ is a musical instrument played using one or several keyboards, producing sounds using sets of sound pipes supplied by a wind tunnel. Each set of pipes is called a “rank.” The keyboards may possibly be completed by a pedal assembly.

Each rank of pipes generally consists of as many pipes as there are keys on a keyboard or pedal assembly. The pipes of a same rank are generally all of the same type and produce a similar timbre. A 16′ flute will therefore designate a rank of 61 open pipes, whereof the first type is a flute whereof the resonator is an open 16 foot pipe. It has a corresponding note corresponding to a Ut 0, or approximately 33 Hz. The last pipe in the rank is then a pipe measuring ½ foot, producing a frequency corresponding to a Ut 5.

The variety of the ranks is important, each rank being characterized by a number of variables: ratio of the length to their diameter, materials (metals and alloys thereof, woods, plastics, etc.), plugged or not, with or without chimneys, cylindrical or conical, ranks with mouths or ranks with reeds, etc. Each of the ranks is characterized by a particular unique timbre.

Registers (or stops) make it possible to match a particular rank of pipes with a keyboard (or pedal assembly).

In order to benefit from the richness of the timbres offered by each type of pipe, it is necessary to have a complete rank of each type of pipe. This does, however, pose bulk problems: typically, an average organ comprises approximately 20 ranks, or approximately 1200 pipes, with dimensions from 16′ (or even 32′) to 1′/32. This complexity excludes the installation of this type of instrument in single-family homes or apartments. Examples of such constructions may be found in the work “The Recent Revolution in Organ Building” by Miller, George Laing, translated from English and annotated by G. Bedart, published in 1914.

Document FR 748,970 proposes individually adapting the pipe diameter, height and mouth width parameters so as to adapt each pipe to the particular acoustics of the location in which the organ is used. This document proposes varying these parameters in any way within a same rank. Lastly, the variability of these parameters is insufficient to produce timbre variations generally corresponding to different registers.

So-called positive mobile organs exist with more modest dimensions. Nevertheless, this type of organ has the drawback of only having a small number of registers, which are all uniform, which considerably impoverishes the richness of the available timbres.

### AIMS OF THE INVENTION

The present invention aims to provide a compact rank of organ pipes having a significant variety of tempers.

In particular, the present invention seeks to combine harmonically poor pipes for the lowest frequencies with harmonically rich pipes for the middle frequencies without having an audible discontinuity in terms of the timbre between two adjacent notes.

The present invention also aims to propose particular combinations of tones.

### BRIEF DESCRIPTION OF THE INVENTION

The present invention discloses a rank of organ pipes comprising at least 54 pipes, characterized in that said rank has a variation in the richness of the harmonics generated by said pipes during use, and in that the ratio of the intensity of the first harmonic to the intensity of the fundamental is at a maximum at a frequency between 150 and 500 Hz, preferably between 200 and 300 Hz, wherein said maximum is different by at least 20 dB (preferably 30 dB) with respect to the ratio of the intensity of the first harmonic to the fundamental of the pipe producing the lowest frequency note.

“Rank of organ pipes” refers to a set of pipes distributed according to a predetermined gamut, each pipe producing a distinct note.

“Richness of the harmonics or timbre” in the present invention refers to the number of audible harmonics and the intensity ratios between the fundamental frequency and the harmonics.

According to particular preferred embodiments of the invention, the rank of organ pipes comprises one or a suitable combination of the following features:
the rank includes pipes producing notes distributed from least ut 1 (66 Hz) up to at least ut 5 (1 kHz) and in that the ratio of the intensity of the first harmonic to the fundamental frequency has a difference between ut 3 (approximately 260 Hz) and ut 1 (approximately 66 Hz) greater than approximately 30 dB;
the pipes are flue pipes;
the variation of the harmonics is obtained by using at least three types of pipes selected from the group consisting of bourdon, stopped flute, chimney flute, conical flute, flutes, large principals, principals, salicional, viola and piccolo;
the variation of the harmonics is obtained by using, from the lowest frequencies toward the highest frequencies, bourdons, followed by flutes, followed by principals, followed by violas;
the rank of organ pipes comprises chimney bourdons or semi-stopped flutes with chimneys;
the rank of organ pipes comprises pipes with a dual mouth;
the variation of the richness of the harmonics is obtained by using materials with different compositions;
the pipes producing the lowest tones are made from wood, followed by Pb/Sn alloys, the pipes made from alloys producing the lowest tones comprising more Pb than the pipes producing the highest tones;
the variation of the richness of the harmonics is obtained by varying the ratio of their length to their circumference.

The pipes of the bourdons, stopped flute, chimney flute, conical flute, flutes, large principals, principals, salicional, viola, piccolo, chimney bourdon and chimney flute types are described in more detail in the reference work by Dom Bedos de Celles: “l'art du facteur d'orgues” published in 1766 that we Incorporate here by reference. In particular, pages 37 to 57 describe the traditional ranks, pages 58 to 84 describe the pitches thereof, and plate XVI specifies the different forms again.

One particular preferred embodiment of the invention relates to a rank of organ pipes comprising more than 84 pipes distributed over at least 7 octaves, the lowest octave(s) being produced by stopped mouth pipes, the following octave by conical metal pipes, the first pipes of said octave comprising two mouths, the following pipes being less and less conical, up to the cylindrical metal pipes for the last octave(s).

According to another particular preferred embodiment, the invention relates to a rank of organ pipes comprising at least 84 pipes distributed over at least 7 octaves, the lowest octave(s) being produced by bourdons, the following pipes being flutes, followed by principals, the last notes being produced by violas.

A second aspect of the invention relates to a wind instrument comprising a single rank of organ pipes according to the invention and also comprising solenoid valves making it possible to activate each pipe individually, and a control unit controlling the activation of said solenoid valves.

According to particular preferred embodiments, the wind instrument according to the invention comprises one or a suitable combination of the following features:
said control unit comprises at least one MIDI interface to connect at least one keyboard to said control unit;
said control unit also comprises means making it possible to synthesize sounds, preferably in the lowest frequencies (first octave);
said control unit makes it possible to split said single rank into at least two sections;
said control unit makes it possible to associate several pipes with a particular note according to harmonic mixtures;
each note of a mixture is obtained by sounding a pipe producing a frequency f1 simultaneously with a pipe producing a frequency f2=1.5*f1, so as to produce a sound with frequency fo=f1/2.

A third aspect of the invention relates to a particular assembly of organ pipes, making it possible to reduce the spatial bulk of said assembly and to facilitate the manufacture thereof.

This assembly of organ pipes comprises at least two flue pipes made up of a front surface, a rear surface, side walls and partitions separating the individual pipes, the front surface being pierced with mouths having an upper lip and a lower lip in the space defined between the partitions and languids being arranged inside the pipes defining a flue between the lower lips of the mouths and the languids, the cavities defined under the languids comprising means for individually supplying them with wind, and the cavity situated above the languids defining the resonator of each pipe.

According to particular preferred embodiments of the invention, the assembly of organ pipes according to the third aspect of the invention comprises one or a suitable combination of the following features:
the front and rear surfaces of the assembly are situated in secant planes, so as to allow a suitable progression of the depth of the resonators relative to their heights;
the width of each pipe is adapted to the height of the corresponding resonators so as to allow a suitable progression of the width of the resonators relative to their heights;
the front and/or rear surface of the assembly has a stair profile so as to define the individual height of each resonators;
the vertical position of the mouths and the languids is varied so as to adapt the height of the resonators;
the pipes are stopped using mobile buffers making it possible to adjust the height of the resonators;
the front surface is formed in two portions, a lower portion comprising the lower lip of the mouths, and an upper portion comprising the upper lip of the mouths;
the partitions and the walls are assembled to the front and rear surfaces using so-called dovetail assemblies.

A fourth aspect of the invention relates to a method for determining a rank of organ pipes in harmonic progression according to the invention comprising the following steps:
obtaining an organ of the prior art comprising a wide variety of distinct ranks of pipes, preferably at least 10 ranks;
for each rank, measuring the harmonic components of at least one pipe at a minimum of one frequency,
choosing the pipes making up the rank of organ pipes in harmonic progression as a function of the harmonic components measured so that the ratio of the intensity of the first harmonic to the intensity of the fundamental is at a maximum at a frequency between 150 and 500 Hz, preferably between 200 and 300 Hz, said maximum being different by at least 20 dB (preferably 30 dB) relative to the intensity of the ratio of the first harmonic to the intensity of the fundamental of the pipe producing the note at the lowest frequency.

### BRIEF DESCRIPTION OF THE FIGURES

FIG. 1 shows an organ pipe.

FIG. 2 shows the first pipes of each octave of an organ rank according to the invention.

FIGS. 3a, b and c show an example of an assembly of organ pipes according to the third aspect of the invention seen from the front, side and top.

FIG. 4 shows a front view of another example of an assembly of organ pipes according to a third aspect of the invention.

FIG. 5 shows a front view of another example of an assembly of organ pipes according to the third aspect of the invention, where the pipes are bourdons.

FIG. 6 shows a prototype of the rank of pipes according to the invention, comprising, at the rear thereof, an assembly of bourdons according to the third aspect of the invention.

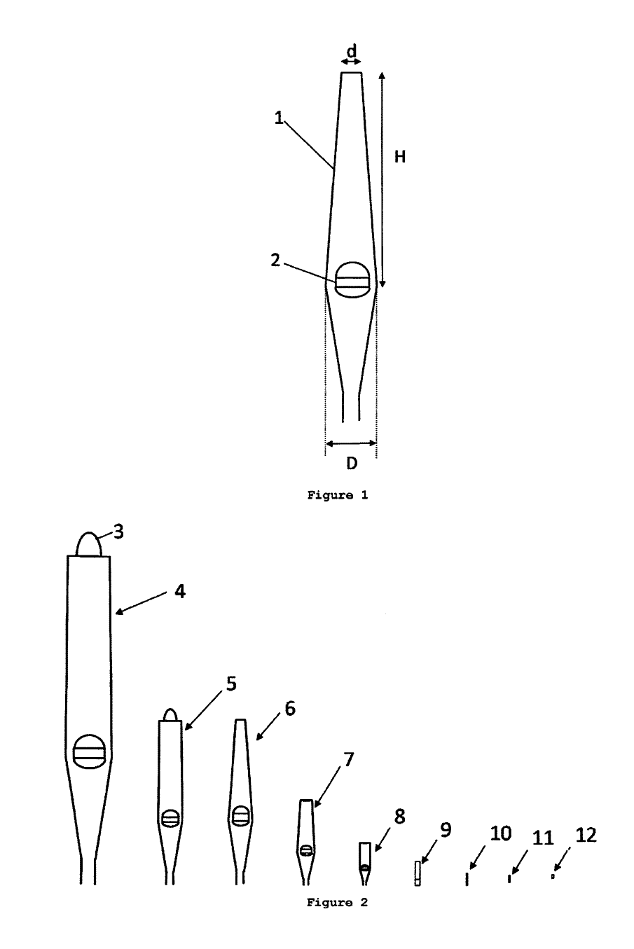

### LEGENDS FOR THE FIGURES

1: resonator
2: mouth
3: buffer
4: Pipe Ut 0
5: Pipe Ut 1
6: Pipe Ut 2
7: Pipe Ut 3
8: Pipe Ut 4
9: Pipe Ut 5
10: Pipe Ut 6
11: Pipe Ut 7
12: Pipe Ut 8
D: diameter of the resonator mouth height
d: diameter of the resonator at the open end thereof or at buffer height.
H: height of the resonator
20: set of pipes
21: mouth
22: height
23: rear surface
24: partition
25: side wall
26: front surface
27: languid
28: dovetail assembly
30: set of pipes
31: mouth
34: partition
40: set of pipes
41: mouth
42: buffer
44: partition
50: transport wheels

### DETAILED DESCRIPTION OF THE INVENTION

The present invention discloses a rank of organ pipes comprising various types of pipes producing a quasi-continuous variation of timbres between two pipes producing adjacent notes.

Unlike the ranks of pipes of the prior art, where the organ manufacturer seeks to obtain a constant timbre within a same rank, the rank of pipes of the present invention will therefore have a voluntarily audible variation from one octave to the next, while preserving the continuity between two adjacent notes. This progression of the timbres within a same rank makes it possible to reduce the number of ranks necessary for a given timbre richness, and thus opens the possibility of producing mobile devices that are not too bulky. This small bulk opens the possibility of using this type of instrument in cramped locations, such as individual residences or cramped concert rooms.

Preferably, the pipes producing the most brilliant sounds (the richest in harmonics) will be the pipes producing the middle frequency tones (i.e. the octaves from Ut 2 to Ut 4, or frequencies between 200 Hz and 1 kHz). This frequency range corresponds to the mezzosoprano or soprano voice tessituras. These are generally the frequencies to which the human ear is the most sensitive.

Preferably, the ratio of the intensity of the first harmonic to the intensity of the fundamental frequency will vary from one pipe to the next in an increasing monotone manner from the pipes producing the deepest notes to a maximum toward a frequency between 150 and 500 Hz, preferably between 200 and 300 Hz, advantageously toward 250 Hz.

Preferably, the ratio of the intensity difference of the first harmonic to the fundamental intensity will not vary by more than 20 dB over an octave.

Preferably, the ratio of the intensity difference of the second and third harmonics to the fundamental intensity will not vary by more than 25 dB over an octave.

The present invention takes advantage of the gradual timbre variations offered by the wide variety of shapes and materials available to manufacture organ pipes, in particular flue pipes.

For example, the pipes stopped by a buffer 3 producing stationary waves having a localized widening at mouth height of the pipe and a node at the closed end thereof, only the resonance modes having an odd quarter wave retarder number will be perceptible. This will therefore result in a fundamental fo corresponding to one quarter wavelength, followed by the second harmonic having a frequency 3*fo corresponding to three-quarter wavelength, and so forth.

In so-called “chimney” stopped pipes, the presence of an opening in the buffer makes it possible to produce several even harmonics (½ wave and 3/2 wave in addition to ¼ and ¾ wave). These chimney pipes may produce richer harmonics than certain conical open pipes.

For the open pipes, the richness of the harmonics may be varied by modifying the taper of the resonator 1: the smaller the diameter d of the open end relative to the diameter D of the resonator 1 at mouth height, the less the high harmonics will be present.

The presence of a second mouth may make it possible to still further reduce the transition between stopped pipes and conical flutes. In fact, this transition between the stopped pipes in the open flutes poses an additional problem: the stopped pipes have the particularity of practically only producing the odd harmonics, whereas the flutes have a monotone reduction of the intensities of the successive harmonics, even and odd. In particular, the second harmonic (3 fo) is sometimes more intense than the fundamental sound, and the fourth harmonic (5 fo) is also very intense. The conical dual-mouth pipe makes it possible to reduce this gap, by presenting a second harmonic (3 fo) that is more intense than the single-mouth pipe and a slightly reduced first harmonic (2 fo).

Lastly, for pipes having a straight resonator 1 (section at mouth height identical to the section of the other end of the pipe), the richness of the harmonics may also be increased by using smaller diameters D.

In this way, it will be possible to vary the timbre practically continuously within a same pipe rank by starting with the first octave with stopped pipes, continuing with conical pipes having an increasingly smaller taper, followed by cylindrical pipes having a smaller and smaller diameter. Chimney pipes may potentially be inserted into the series of pipes at a location making it possible to respect the quasi-continuous gradation of the richness of the harmonics.

Preferably, the first open conical pipes will have a dual mouth, so as to soften the transition between stopped pipes and open pipes.

The second parameter making it possible to vary the timbre of the pipe is the rigidity of the material used to manufacture it. Thus, for a given shape, the more rigid the material, the more it will tend to generate high harmonics. Thus, it will be possible to produce a gradation from the poorest harmonics toward the richest harmonics in the following order: plastic, soft wood, hard wood, Pb, Sn.

A quasi-continuous gradation may for example be obtained by using a Pb/Sn alloy whereof the proportions of Pb are varied from one pipe to the next (or from one octave to the next).

Lastly, to a lesser extent, other parameters such as the shape of the mouth 2 (width/height ratio) may also contribute to the quasi-continuous variation of the pipe timbre within a same rank.

The present invention is not limited to flue pipes, but may easily be transposed to other types of pipes, such as reed pipes.

In order to reduce the bulk caused by the large bourdon pipes (16′ and 8′ octave in particular), a new type of pipe assembly is also disclosed.

This organ pipe assembly comprises at least two flue pipes made up of a front surface, a rear surface, side walls and partitions separating the individual pipes. The rear surface is advantageously made from a single piece, while the front surface may be made up of two pieces extending laterally over the group of pipes.

Alternatively, the front surface is also produced in a single piece.

The front surface is pierced with mouths having an upper lip and a lower lip in the space defined between the partitions. Languids are arranged inside the pipes defining a flue between the lower lips of the mouths and the languids.

In the case where the front surface is made in two portions, the lower portion comprises the lower lip of the mouths, and the upper portion comprises the upper lip of the mouths.

The cavities defined under the languids comprise means for individually supplying them with wind, and the cavities situated above the languids define the resonator of each pipe.

Preferably, the front and rear surfaces of the assembly are situated in secant planes, so as to allow a suitable progression of the depth of the resonators relative to their heights.

Advantageously, the width of each pipe is adapted to the height of the corresponding resonators so as to allow a suitable width progression of the resonators relative to their height.

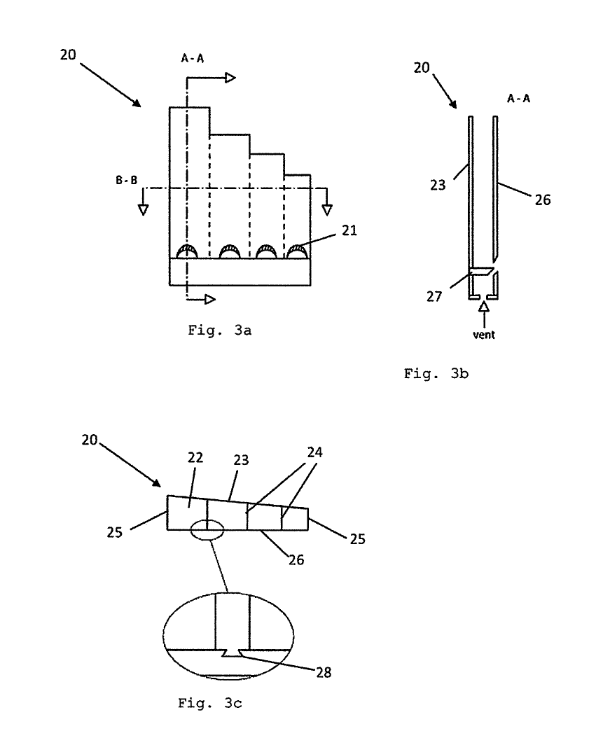

Preferably, the front and/or rear surface of the assembly has a stair profile so as to define the individual height of each resonator, as shown in FIG. 3.

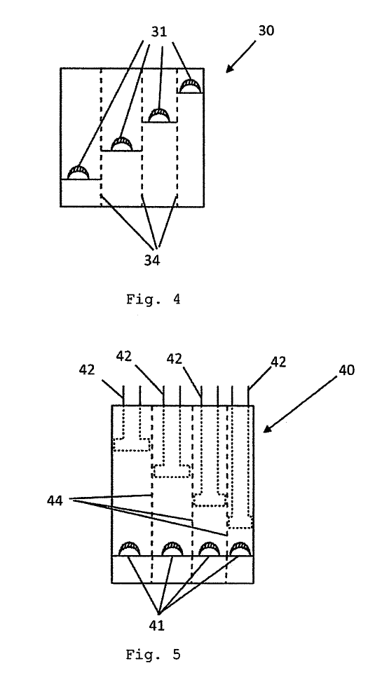

Alternatively, the vertical position of the mouths of the languids is varied so as to adapt the height of the resonators as shown in FIG. 4.

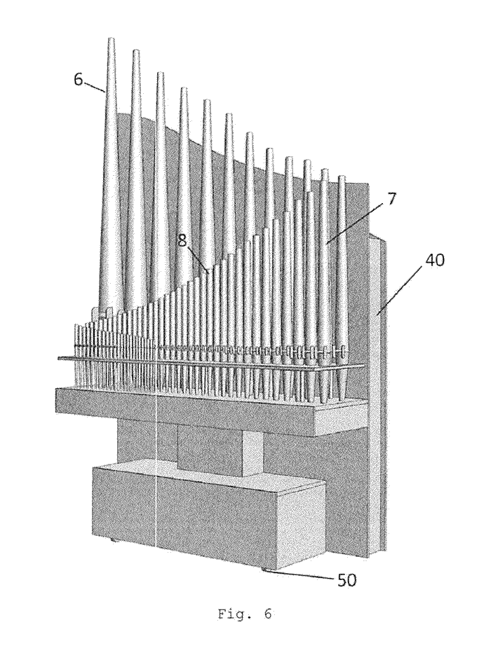

Advantageously, the pipes are stopped using movable buffers making it possible to adjust the height of the resonators as shown in FIG. 5.

Advantageously, the partitions of the walls are assembled to the front and rear surfaces using so-called dovetail assemblies. In this case, nevertheless, in order to facilitate the assembly, the front and rear surfaces will preferably be parallel. This type of assembly can for example be obtained from the “bwatakoulys” construction described in document EP1022968.

The rank of pipes according to the invention may be used as an additional rank in a traditional organ, but will preferably be used in a similar wind instrument, but only physically having a single rank of pipes.

In these instruments, the pipes are supplied through a wind chest via an electric blower. The supply of wind for each pipe is controlled individually by solenoid valves controlled by a control unit or combiner.

The control unit will preferably comprise one or several MIDI type interfaces, to be able to connect one or more MIDI-compatible keyboards.

The correspondence between the keys of the keyboard and the pipes may be done through a number of divisions: either so-called fundamental divisions, according to which the first key of the keyboard corresponds to a Ut of one of the octaves previously defined, or so-called mutation divisions for which the first key of the keyboard corresponds to another pipe, like that corresponding to a flute measuring 10 feet ⅔ (fifth), 5 feet ⅓ (fifth), 1 foot 1/3/5 (third), etc.

Generally, the mutations will be associated with a fundamental division using separate keyboards.

The combiner may also propose mixtures, in which several pipes correspond to a single key of the keyboard, according to predetermined harmonies. These mixtures typically associate one fundamental and one or more harmonics, or other harmonic combinations.

These mixtures also make it possible to generate resulting sounds at lower frequencies than the fundamental frequency, which makes it possible to simulate the presence of pipes larger than the pipes actually present. For example, a 32 foot rank may be simulated by using a mixture simultaneously actuating a fundamental frequency and its fifth (or at respective frequencies fo and 1.5*fo, producing a resultant at fo/2).

The first octave may potentially also be produced by a synthesizer, so as to reduce the bulk caused by the presence of 8′ stopped pipes (producing sounds corresponding to 16′ open flutes).

More generally, the rank of pipes of the present invention can advantageously be associated with a synthesizer, including over the entire gamut. In that case, the progression of the different pipes will be adapted as a function of the desired progression of the synthesizer. This association of the rank of pipes of the invention with a synthesizer makes it possible to associate the “living” sounds of the real organ pipes with the synthetic sounds of the synthesizer.

### Example

A musical instrument prototype according to one preferred embodiment of the invention has been produced according to the specifications below.

The organ of the example embodiment of the invention comprises a single rank of 109 pipes, distributed over 9 octaves, from Ut 0, corresponding to a 16 foot flute up to Ut 8 plus a pipe for Ut 9, corresponding to a 1/32 foot flute, each octave comprising 12 half-tones.

To facilitate the description of the invention, we will more particularly describe the first pipe of each octave, and possibly the particular position in the gamut of other discontinuous transitions, although having a continuous variation of the timbre of the pipes. It is understood that parameters like the taper or diameter have been varied continuously, even within a same octave.

The first twelve pipes, forming the first octave, are made up of wooden pipes 4 comprising a buffer 3 at the end of the resonator, thereby making it possible to reduce the bulk for a given note. These stopped pipes correspond to the traditional appellation of the bourdon pipes. The first pipe is an 8′ stopped pipe, therefore producing a sound corresponding to a 16′ open pipe, or a Ut 0 at approximately 32 Hz. The square section has a side measuring 25 cm.

The second octave (Ut 1) 5 is also made up of twelve stopped wooden pipes. These stopped pipes correspond to stopped flutes according to the traditional appellation. The first pipe is a 4′ stopped pipe, therefore producing a sound corresponding to an 8′ open pipe, or a Ut 1 at approximately 64 Hz. The square section has a side measuring 13.5 cm.

The first pipes of the third octave (Ut 2) are conical pipes 6 made from a Pb/Sn alloy rich in Pb. The Sn concentration of that alloy in the first pipe of that octave is 15%. The diameter at mouth height of said first pipe is 12 cm, while the diameter of its free end is 2 cm. The first pipes of this octave also have the particularity of being “dual-mouth.” Aside from the “dual mouth” particularity, these pipes correspond to flue flutes.

From the Sol (G) of this third octave, the second mouth is eliminated, and the composition is enriched to 20% with tin.

The fourth octave is made up of twelve conical pipes 7 made from the Pb/Sn alloy, whereof the Sn content this time is 35%. The Ut3 of this octave has a diameter at mouth height of 4.6 cm, for a diameter at its free end of 3 cm. These pipes correspond to the traditional appellation of conical flutes.

The fifth octave is made up of two cylindrical pipes 8 whereof the lead content is 50%. The diameter of the Ut4 is 2.6 cm. These pipes correspond to large principals.

The sixth octave is made up of twelve cylindrical pipes 9 whereof the Sn content is 60%. The diameter of the Ut5 is 1.8 cm. They correspond to piccolos according to the traditional appellation.

The rank of pipes following the Ut6 has a tin level of 70% and corresponds to Piccolos according to the traditional name. The diameter of the Ut6 is 1.3 cm.

A single pipe 12 closes the eighth octave with a Ut9, pipe whereof the composition and shape are identical to those of the pipe of the ninth octave.

An instrument prototype according to this example is shown in FIG. 6 (the octave starting at Ut0 is not shown). In this prototype, the pipes corresponding to the octave starting at Ut1 are made up of a pipe assembly 40.

Acoustic measurements were done on the pipes of this example, demonstrating the gradual variation of the timbres in the proposed rank. A measurement on a single-mouth pipe was added to the Ut2, so as to verify the efficacy of such a modification. This pipe is identical to the pipe Ut2 of the example, with the exception of the dual mouth. It will be noted that the presence of the second mouth makes it possible to slightly reduce the first harmonic and increase the second significantly, which significantly reduces the transition between the timbre of the stopped mouths and that of the first open pipes.

The measurements were done in the manufacturing workshop of the organ, but two simultaneous measurements in two locations of that workshop made it possible to verify the absence of artifacts due to the piece. Lastly, it should be noted that the measurements were done before the instrument was tuned, the notes not absolutely corresponding to the note of the traditional scale (in particular for the last ut).

The sounds were recorded using two micro AudioTechnica At-3032, connected on a PCM D50 digital recorder, using a Sony XLR-1 adapter. The sounds obtained were then processed by Fourier transform (FFT) so as to extract the spectral components thereof. For each measurement, the intensity of the fundamental component of the different harmonics was calculated and related to the most intense component (0 dB for the most intense component). The results are shown in table 1.

For the transition between the stopped pipes and the open pipes, note will be made of the particular evolution of the first and second harmonics: from an attenuation of 6 dB for Ut 1, followed by a second harmonic attenuated by 30 dB for Ut 2 and an attenuation of 38 dB for Sol 2. It should be noted that the dual mouth makes it possible to attenuate the transition: 30 dB of attenuation instead of 48 dB for the single-mouth pipe. For the first harmonic, one goes from 37, then 16, 4 and 1 dB of attenuation of the first harmonic relative to the fundamental, which presents an inaudible gradation from one note to the note a half-tone higher.

It should be noted that beyond Ut4, the harmonics decrease regularly, these harmonics being at frequencies only slightly audible by the human ear.

The example of a rank of pipes presented above is one possible embodiment of the invention among others. In fact, one skilled in the art will easily understand what types of pipes to combine from one octave to the next to obtain more or less harmonically rich tones.

According to one method of the invention, the progression of the shapes and materials will be determined by measuring the harmonic components of different ranks of the same organ to deduce therefrom what type of pipes to be used to obtain a progression of timbres according to the invention. In this manner, provided one has access to an organ comprising enough different ranks, one will have a significant number of different pipe types making it possible to determine which ones to use.

| | Frequency | Relative harmonics levels (dB), the strongest | | | | | | | | |
|---|---|---|---|---|---|---|---|---|---|---|
| Frequency (multiple of | (Hz) | harmonic being used as reference (0 dB) | | | | | | | | |
| Fo) | Fo | Fo | 2Fo | 3Fo | 4Fo | 5Fo | 6Fo | 7Fo | 8Fo | 9F0 |
| Ut1 (8′) | 64 | 0 | −37 | −6 | −31 | −28 | −31 | −45 | −43 | −44 |
| Ut2 (4′) dual mouth | 127 | 0 | −16 | −30 | −34 | −62 | −59 | −65 | −71 | −73 |
| Sol2 (single mouth) | 190 | 0 | −4 | −38 | −41 | −36 | −39 | −38 | −44 | −45 |
| Ut3 (2′) | 252 | 0 | −1 | −23 | −36 | −42 | −39 | −39 | −43 | −48 |
| Ut4 (1′) | 506 | 0 | −10 | −25 | −34 | −32 | −39 | −36 | −50 | −49 |
| Ut5 (½′) | 1010 | 0 | −19 | −25 | −39 | −39 | −54 | −46 | −51 | −57 |
| UT6 (¼′) | 2017 | 0 | −25 | −33 | −54 | −48 | −47 | −51 | −62 | |
| Ut7 (⅛′) | 4023 | 0 | −31 | −35 | −50 | Harmonics outside | | | | |
| Ut8 ( 1/16′) | 7666 | 0 | −30 | the audible frequencies | | | | | | |
| Ut9 ( 1/32′) | 11940 | 0 | | | | | | | | |
| Ut2 (4′) single mouth | 117 | 0 | −11 | −47 | −38 | −37 | −41 | −43 | −45 | −53 |

1. A rank of organ pipes comprising:
at least 54 organ pipes, having a ratio of the intensity of the first harmonic to the intensity of the fundamental at a maximum at a frequency between 150 and 500 Hz, wherein said maximum is different by at least 20 dB with respect to the ratio of the intensity of the first harmonic to the fundamental of the pipe producing the lowest frequency note.

2. The rank of organ pipes according to claim 1, wherein the rank includes pipes producing notes distributed from least ut 1 (66 Hz) up to at least ut 5 (1 kHz); and
wherein the ratio of the intensity of the first harmonic to the fundamental frequency has a difference between ut 3 (approximately 260 Hz) and ut 1 (approximately 66 Hz) greater than approximately 30 dB.

3. The rank of organ pipes according to claim 1, wherein pipes are flue pipes.

4. The rank of organ pipes according to claim 1, wherein the variation of the harmonics is obtained by using at least three types of pipes selected from the group consisting of bourdon, flue flute, spindle flute, conical flute, flutes, large principals, principals, salicional, viola and piccolo.

5. The rank of organ pipes according to claim 4, further comprising pipes selected from the group consisting of chimney bourdons and semi-stopped flutes with chimneys.

6. The rank of organ pipes according to claim 4, further comprising pipes with a dual mouth.

7. The rank of organ pipes according to claim 4, wherein the pipes comprise materials of differing compositions.

8. The rank of organ pipes according to claim 7, wherein the pipes producing the lowest tones are made from materials from the group consisting of wood, and Pb/Sn alloys.

9. The rank of organ pipes according to any claim 1, wherein the variation of the harmonics is obtained by varying the ratio of pipe length to pipe circumference.

10. A wind instrument comprising a single rank of organ pipes according to claim 1 further comprising a plurality of solenoid valves adapted to activate each organ pipe individually; and
a control unit for controlling the activation of the plurality of solenoid valves.

11. The wind instrument according to claim 10, wherein said control unit comprises at least one MIDI interface connected to at least one.

12. The wind instrument according to claim 11: wherein the control unit further comprises means for synthesizing sounds, preferably in the lowest frequencies.

13. The wind instrument according to claim 10, wherein the control unit is further adapted to permit the single rank to be divided into at least two sections.

14. The wind instrument according to any one of claim 10 wherein the control unit is further adapted to associate several organ pipes with a particular note for creating a harmonic mixture.

15. The wind instrument according to claim 14, wherein each note of the harmonic mixture is obtained by sounding an organ pipe producing a frequency f1 simultaneously with a pipe producing a frequency f2=1.5*f1, thereby producing a sound with frequency fo=f1/2.

16. A method for determining a rank of organ pipes in harmonic progression comprising:
obtaining an organ of the prior art comprising a plurality of ranks of pipes;
for each rank, measuring the harmonic components of at least one pipe at a minimum of one frequency
choosing the pipes making up the rank of organ pipes in harmonic progression as a function of the harmonic components measured so that the ratio of the intensity of the first harmonic to the intensity of the fundamental is at a maximum at a frequency between 150 and 500 Hz, said maximum being different by at least 20 dB relative to the intensity of the ratio of the first harmonic to the intensity of the fundamental of the pipe producing the note at the lowest frequency.

17. An assembly of organ pipes comprising at least two flue pipes each comprising a front surface, a rear surface, two side walls, and at least one partition separating the individual flue pipes, the front surface being pierced with mouths having an upper lip and a lower lip in the space defined between the partitions, and languids being arranged inside the flue pipes defining a flue between the lower lips of the mouths and the languids, cavities defined under the languids comprising means for individually supplying the cavities with wind, and cavities situated above the languids defining the resonator of each pipe.

18. The assembly of organ according to claim 17, wherein the front and the rear surfaces of the assembly of organ pipes are situated in secant planes, thereby allowing a suitable progression of the depth of the resonators relative to their heights.

19. The assembly of organ pipes according to claim 17, wherein the width of each flue pipe is adapted to the height of the corresponding resonators thereby allowing a suitable progression of the width of the resonators relative to their heights.

20. The assembly of organ pipes according to Claim 17, wherein the front surface and rear surface of the assembly of organ pipes each has a stair profile so as to define the individual height of each resonators.

21. The assembly of organ pipes according to claim 17, wherein the vertical position of the mouths and the languids is varied so as to adapt the height of the resonators.

22. The assembly of organ pipes according to claim 17, wherein vertical openings are formed in the top of the rear surface, said vertical openings emerging in each pipe and extending as far as the upper edge of said rear surface, the height of the openings comprising a sliding slat adapted to adjust the dimensions of the openings, thereby allowing tunings of the fundamental vibration frequency of each individual organ pipe.

23. The assembly of organ pipes according to claim 17, wherein the organ pipes are stopped using mobile buffers, the mobile buffers adapted to adjust the height of the resonators.

24. The assembly of organ pipes according to claim 17, wherein the front surface comprises a lower portion comprising the lower lip of the mouths and an upper portion comprising the upper lip of the mouths.

25. The assembly of organ pipes according to claim 17, wherein the partitions of the side walls are assembled to the front and rear surfaces using dovetail assemblies.

26. The rank of organ pipes according to claim 1, wherein the ratio of the intensity of the first harmonic to the intensity of the fundamental is at a maximum at a frequency between preferably between 200 and 300 Hz.

27. The method for determining a rank of organ pipes in harmonic progression of claim 16, wherein the ratio of the intensity of the first harmonic to the intensity of the fundamental is at a maximum at a frequency preferably between 200 and 300 Hz.
